(19) United States
(12) Patent Application Publication
(10) Pub. No.: US 2015/0159027 A1
(43) Pub. Date: Jun. 11, 2015

(54) CONNECTOR AND CABLE ABSORBING LOW FREQUENCY ELECTROMAGNETIC WAVES

(71) Applicant: Hyundai Motor Company, Seoul (KR)

(72) Inventors: Inchang Chu, Seoul (KR); Jinwoo Kwak, Gyeongsan (KR)

(21) Appl. No.: 14/339,969

(22) Filed: Jul. 24, 2014

(30) Foreign Application Priority Data
Dec. 9, 2013 (KR) 10-2013-0152535

(51) Int. Cl. C09D 5/32

(52) U.S. Cl. CPC C09D 5/32

(57) ABSTRACT

A connector and a cable can absorb low frequency electromagnetic waves when formed of a material including a conductive nanomaterial and a magnetic metal material. Because the conductive nanomaterial and a magnetic metal nanowire or nanoparticle have high permeability as compared to the conductive nanomaterial alone, low frequency electromagnetic waves can be absorbed, and electrical interference among various electric/electronic parts can be minimized.

### CROSS-REFERENCE TO RELATED APPLICATION

This application claims under 35 U.S.C. §119(a) priority to and the benefit of Korean Patent Application No. 10-2013-0152535 filed in the Korean Intellectual Property Office on Dec. 9, 2013, the entire contents of which are incorporated herein by reference.

### BACKGROUND

(a) Field of the Invention

The present invention relates to a connector and a cable absorbing low frequency electromagnetic waves. More particularly, the present invention relates to a connector and a cable that can absorb low frequency electromagnetic waves when a high voltage connector and/or high voltage cable are manufactured by mixing conductive nanomaterial and a magnetic metal material.

(b) Description of the Related Art

The use of electric/electronic parts in vehicle manufacturing has increased, as has the requirement thr high integration of electric/electronic parts. Accordingly, there is a problem that interference caused by electromagnetic waves among the electric/electronic parts must be avoided, and the weight of electric/electronic parts should be reduced.

Electric/electronic parts are provided in an electric vehicle or hybrid vehicle. The electric/electronic, parts include a control apparatus such as an MCU (motor control unit) and a PCU (power control unit). A cable and a connector are connected to the control apparatus and the electric/electronic parts in order to supply high voltage power. However, electrical interference is generated among the electric/electronic parts by the electromagnetic waves generated inside and outside of the various control apparatuses and the electric/electronic parts, and there is a problem that a malfunction of the electric/electronic parts may occur.

According to the prior art, blocking of electromagnetic waves both inside and outside of the electric/electronic parts such as the MCU or PCU has been performed using metal plates or aluminum foil such that the electromagnetic waves generated inside and outside of various control apparatuses are blocked from leaking to the outside.

As described above, when the electromagnetic waves generated inside and outside of various control apparatuses are simply blocked, the intensity of the electromagnetic waves is not attenuated, and a possibility of interference among the electric/electronic parts still exists. Therefore, it is required that the intensity of the electromagnetic waves be attenuated.

Further, since various control apparatuses are blocked by using metal plates or aluminum foil, assembly efficiency is reduced, weight of various parts is increased, and manufacturing cost is increased.

Particularly, commercial products for absorbing high frequency electromagnetic waves over 1 GHz have been developed, but a material for absorbing low frequency electromagnetic waves has not been developed. Since the electromagnetic waves generated from a high voltage connector applied to a high voltage inverters are low frequency electromagnetic waves, a material for absorbing low frequency electromagnetic waves has been increasingly required.

The above information disclosed in this Background section is only for enhancement of understanding of the background of the invention and the fore it may contain information that does not form the prior art that is already known in this country to a person of ordinary skill in the art.

### SUMMARY

The present invention provides a connector and a cable that can absorb low frequency electromagnetic waves.

Further, the present invention provides a connector and a cable for preventing malfunction of various electric/electronic parts caused by low frequency electromagnetic waves.

In addition, the present invention provides a connector and a cable that can absorb low frequency electromagnetic waves, simplify a manufacturing process, and reduce weight of parts.

A connector absorbing low frequency electromagnetic waves according to an exemplary embodiment of the present invention includes a conductive nanomaterial and a magnetic metal.

The conductive nanomaterial may be carbon black, carbon fiber, carbon nanotubes, graphite nanoplate, or a mixture of them.

The magnetic metal may be Fe, Co, Ni, FeSi, an iron alloy, a cobalt alloy, a nickel alloy, or a mixture of them.

The connector absorbing low frequency electromagnetic waves further includes a metal material or a mesh material.

The metal material may be Al, Cu, or a mixture of them.

The mesh material may be a fiber material or glass fiber.

The connector may include a body portion having a terminal and formed of a polymer compound, and a coating material wrapping either inside or outside of the body portion, the coating material being a mesh material coated with a conductive nanomaterial, a magnetic metal, or a metal material.

A cable absorbing low frequency electromagnetic waves according to another exemplary embodiment of the present invention includes a conductive nanomaterial and a magnetic metal.

The conductive nanomaterial may be carbon black, carbon fiber, carbon nanotubes, graphite nanoplate, or a mixture of them.

The magnetic metal may be Fe, Co, Ni, FeSi, an iron alloy, a cobalt alloy, a nickel alloy, or a mixture of them.

The cable absorbing low frequency electromagnetic waves further includes a metal material or a mesh material.

The metal material may be Al, Cu, or a mixture of them.

The mesh material may be a fiber material or glass fiber.

The cable may be made of a coating material, and the coating material may be the mesh material coated with the conductive nanomaterial, magnetic metal, or metal material.

### BRIEF DESCRIPTION OF THE DRAWINGS

The drawings are provided for reference in describing exemplary embodiments of the present invention, and the spirit of the present invention should not be construed only by the accompanying drawings.

FIG. 1 is a perspective view illustrating an MCU with a connector absorbing low frequency electromagnetic waves according to an exemplary embodiment of the present invention.

FIG. 2 is a perspective view illustrating a connector absorbing low frequency electromagnetic waves according to an exemplary embodiment of the present invention.

FIG. 3 is a perspective view illustrating a cable absorbing low frequency electromagnetic waves according to an exemplary embodiment of the present invention.

FIG. 4 is a graph illustrating absorbing performance of electromagnetic waves according to different materials of a connector and a cable.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In describing the present invention, parts that are not related to the description will be omitted. Like reference numerals generally designate like elements throughout the specification.

In addition, the size and thickness of each configuration shown in the drawings are arbitrarily shown for better understanding and ease of description, but the present invention is not limited thereto. In the drawings, the thickness of layers, films, panels, regions, etc., are exaggerated for clarity.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

A connector absorbing low frequency electromagnetic waves and a high voltage cable according to an exemplary embodiment of the present invention will now be described with reference to drawings.

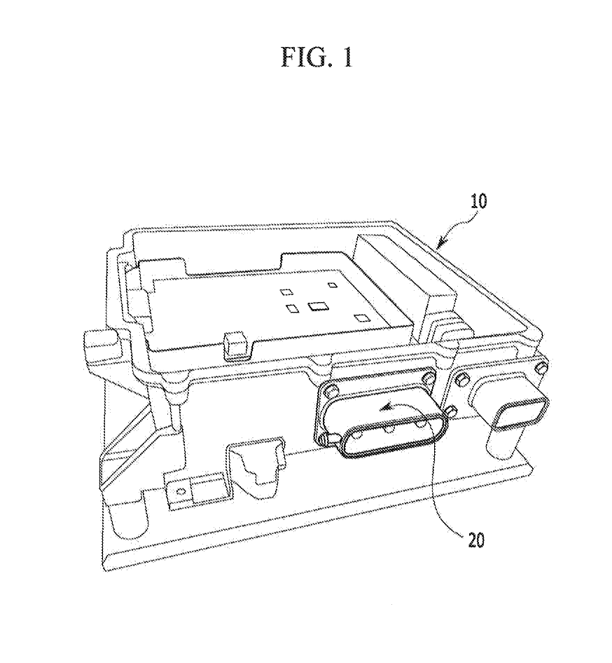

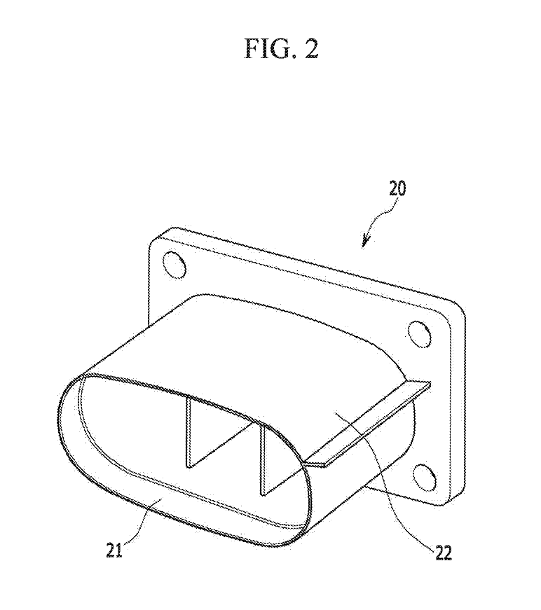

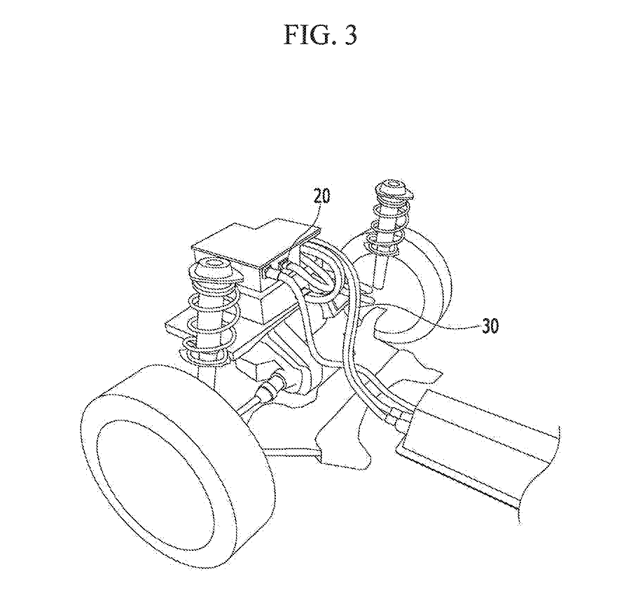

FIG. 1 is a perspective view illustrating an MCU 10 with a connector absorbing low frequency electromagnetic waves according to an exemplary embodiment of the present invention. FIG. 2 is a perspective view illustrating a connector 20 absorbing low frequency electromagnetic waves according to an exemplary embodiment of the present invention. FIG. 3 is a perspective view illustrating a cable 30 absorbing low frequency electromagnetic waves according to an exemplary embodiment of the present invention.

As shown in FIGS. 1-3, the connector 20 and the cable 30 absorbing low frequency electromagnetic waves according to an exemplary embodiment of the present invention are made of a material including a conductive nanomaterial and a magnetic metal.

An electric wire is provided in the cable 30 for supplying power.

The conductive nanomaterial may be carbon black (CB), carbon fiber (CF), carbon nanotubes (CNT), graphite nanoplate (GNP), or a mixture of them.

The magnetic metal may be iron (Fe), nickel (Ni), ferrosilicon (FeSi), an iron alloy, a cobalt alloy, a nickel alloy, or a mixture of them.

The conductive nanomaterial and the magnetic metal have a characteristic that they absorb electromagnetic waves generated from various electric/electronic devices provided in a vehicle.

The connector 20 and the cable 30 absorbing low frequency electromagnetic waves according to an exemplary embodiment of the present invention may be made of a material further including a metal material or a mesh material.

The metal material may be aluminum (Al), copper (Cu), or a mixture of them. The metal material has a characteristic that it blocks electromagnetic waves, and some electromagnetic waves are absorbed and some of electromagnetic waves are blocked by using the metal material along with the conductive material or magnetic metal.

The mesh material may be a general fiber material or a glass fiber (GF). The general fiber material means a type of fiber woven by using a warp and a weft, and the general fiber material may be an animal fiber or a vegetable fiber. Alternatively, the general fiber material may be a polymer compound fiber such as a polyester fiber or a nylon fiber.

The cable 30 absorbing low frequency electromagnetic waves according to an exemplary embodiment of the present invention may be manufactured by injection molding. At this time, the conductive nanomaterial and the magnetic metal is mixed as a molding material for the injection molding. A polymer compound such as polypropylene (PP), polyethylene (PE), or polyurethane and the conductive nanomaterial the magnetic metal may by mixed to provide the molding material as necessary.

As described above, since the cable is manufactured by injection molding using the molding material mix of the polymer compound and the conductive nanomaterial and magnetic metal, strength, heat resistance, flame retardancy, and electrical insulation of the connector 20 can be acquired, and a characteristic of absorbing electromagnetic waves can be simultaneously provided.

When the high voltage cable 30 is manufactured, it is possible for the metal material to be fused along with the conductive nanomaterial and the magnetic metal. When the high voltage cable 30 is manufactured by mixing the conductive nanomaterial and the magnetic metal and metal material, the electromagnetic waves generated at various electric/electronic devices provided in the vehicle can be absorbed and blocked.

Alternatively, the mesh material may be coated with the conductive nanomaterial or the magnetic metal or metal material, and the connector 20 formed of a polymer compound may be wrapped in the coated mesh material.

As described above, since the mesh material is woven by using the warp and the weft, electromagnetic waves of a predetermined frequency can be blocked according to sizes of pores formed by the warp and the weft.

When the conductive nanomaterial or the magnetic metal or the metal material is coated with the mesh material, the electromagnetic waves generated at various electric/electronic devices provided in the vehicle can be absorbed and blocked simultaneously.

As shown in FIG. 2, the connector absorbing low frequency electromagnetic waves according to an exemplary embodiment of the present invention may include a body portion 21 formed of a polymer compound, and a coating material 22 wrapping either inside or outside of the body portion 21. The coating material may be the mesh material coated with the conductive nanomaterial, magnetic metal, or metal material. A terminal for supplying power is disposed in the body portion 21.

As such, since the body portion 21 is manufactured of the polymer compound and the coating material 22 is wrapped either inside or outside of the body portion 21 for absorbing the low frequency electromagnetic waves, the shape of the connector can be formed and low frequency electromagnetic waves generated near the connector can be absorbed.

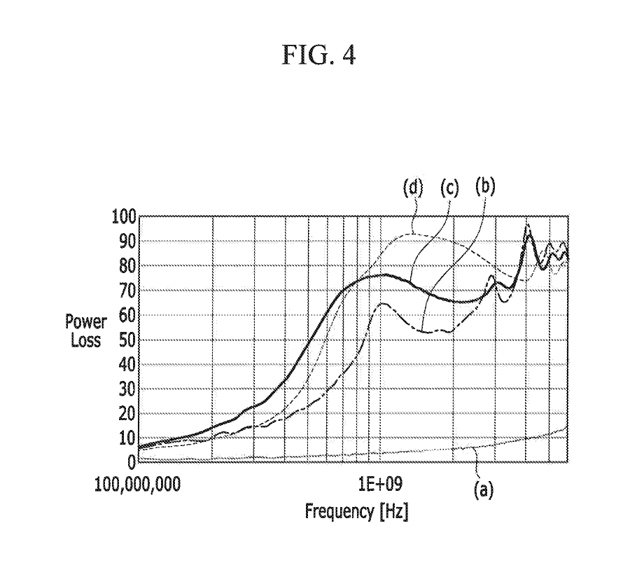

FIG. 4 is a graph illustrating absorbing performance of electromagnetic waves according to different material of a connector and cable. In the graph of FIG. 4, the horizontal axis shows a frequency of the electromagnetic waves in a log scale, and the vertical axis shows absorbing performance of the electromagnetic waves by the material. There are various indexes indicating absorbing performance of electromagnetic waves, but the present invention measures the absorbing performance of the electromagnetic waves by using electrical power loss. The electrical power loss is a measured value of an output electrical power ratio according to an input electric power. That the electrical power loss is high means that the absorbing performance of the electromagnetic waves is high.

An (a) line of FIG. 4 shows electrical power loss of a material of polyester, a (b) line shows electrical power loss of a material of polyester coated with a metal, a (c) line shows electrical power loss of a mixed material of a conductive nanomaterial and a magnetic metal, and a (d) line shows electrical power loss of a mixed material of a general plastic material and a magnetic metal.

As shown in the (a) line of FIG. 4, according to the electrical power loss of the material of a general polymer compound, the electrical power loss is very small, and thus electromagnetic waves are not substantially absorbed in almost all frequency bands.

As shown in the (d) line of FIG. 4, according to the electrical power loss of the mixed material of the general plastic material and the magnetic metal, absorbing performance of electromagnetic waves exceeding the 1 GHz frequency band is very high, but the absorbing performance of electromagnetic waves at less than the 1 GHz frequency band is very low.

As shown in the (b) line of FIG. 4, according to the electrical power loss of the material polyester coated with a metal, electromagnetic waves of a relatively to frequency band are absorbed compared to the mixed material of a general plastic material and a magnetic metal, but the electrical power loss is low. Therefore, absorbing performance of electromagnetic waves is relatively low.

As shown in the (c) line of FIG. 4, according to the electrical power loss of the mixed material of the conductive nanomaterial and the magnetic metal, electromagnetic waves of a low frequency band at less than 1 GHz are absorbed compared to the mixed material of the general plastic material and the magnetic metal. Further, since a difference of the electrical power loss is not high compared to the mixed material of the general plastic material and the magnetic metal, absorbing performance of the electromagnetic waves is high.

As described above, when the connector 20 or the cable 30 are manufactured by using the mixed material of the conductive nanomaterial and the magnetic metal, the electromagnetic waves of low a frequency of less than 1 GHz are absorbed efficiently.

According to an exemplary embodiment of the present invention, since a material absorbing low frequency electromagnetic waves is made by mixing a conductive nanomaterial and a magnetic metal nanowire or nanoparticle having high permeability compared to the conductive nanomaterial, low frequency electromagnetic waves can be absorbed and electrical interference among various electric/electronic parts can be minimized.

Further, since a heavy material such as a metal plate or aluminum foil is not used to block electromagnetic waves, parts for absorbing and blocking electromagnetic waves can be reduced in weight.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A connector absorbing low frequency electromagnetic waves, comprising:
a conductive nanomaterial and a magnetic metal.

2. The connector of claim 1,
wherein the conductive nanomaterial is carbon black, carbon fiber, carbon nanotubes, graphite nanoplate, or a mixture of them.

3. The connector of claim 1,
wherein the magnetic metal is Fe, Co, Ni, FeSi, an iron alloy, a cobalt alloy, a nickel alloy, or a mixture of them.

4. The connector of claim 1, further comprising:
a metal material or a mesh material.

5. The connector of claim 4,
wherein the metal material is Al, Cu, or a mixture of them.

6. The connector of claim 4,
wherein the mesh material is a fiber material or glass fiber.

7. The connector of claim 4,
wherein the connector comprises a body portion having a terminal and formed of a polymer compound, and a coating material wrapping either inside or outside of the body portion, the coating material being a mesh material coated with a conductive nanomaterial, a magnetic metal, or a metal material.

8. A cable absorbing low frequency electromagnetic waves, comprising:
a conductive nanomaterial and a magnetic metal.

9. The cable of claim 8,
wherein the conductive nanomaterial is carbon black, carbon fiber, carbon nanotubes, graphite nanoplate, or a mixture of them.

10. The cable of claim 8,
wherein the magnetic metal is Fe, Co, Ni, FeSi, an iron alloy, a cobalt alloy, a nickel alloy, or a mixture of them.

11. The cable of claim 8, further comprising:
a metal material or a mesh material.

12. The cable of claim 11,
wherein the metal material is Al, Cu, or a mixture of them.

13. The cable of claim 11,
wherein the mesh material is a fiber material or glass fiber.

14. The cable of claim 11, wherein
the cable is made of a coating material, and the coating material is the mesh material coated with the conductive nanomaterial, magnetic metal, or metal material.
